(19) United States
(12) Patent Application Publication
(10) Pub. No.: US 2025/0103784 A1
(43) Pub. Date: Mar. 27, 2025

(54) SYSTEM AND METHOD TO DEVELOP FIRMWARE USING SYSTEM VIRTUALIZATION BASED CO-SIMULATION

(71) Applicant: Microsoft Technology Licensing, LLC, Redmond, WA (US)

(72) Inventors: Xiang MA, Portland, OR (US); Aanchal GUPTA, Hillsboro, OR (US)

(21) Appl. No.: 18/476,072

(22) Filed: Sep. 27, 2023

(51) Int. Cl. G06F 30/3308; G06F 30/327; G06F 111/02

(52) U.S. Cl. CPC G06F 30/3308; G06F 30/327; G06F 2111/02

(57) ABSTRACT

Embodiments of the present disclosure include techniques for simulating circuits, such as systems-on-a-chip (SoC). In various embodiments, a circuit being simulated may comprise one or more processors. However, simulation of the circuit using a hardware description language (HDL) may use a virtualized processor to execute firmware instructions rather than simulating the processor using HDL. Certain instructions from the virtualized processor may be sent, during simulation, to the HDL simulation for execution.

### BACKGROUND

The present disclosure relates generally to firmware development, and in particular, to a system and method to develop firmware using system virtualization based co-simulation.

Simulating circuits is often performed using hardware description language code executing on simulators, such as simulators offered by Synopsys® or Cadence®. For very large circuits including many functional blocks, such simulations may take a long time to perform. This is especially the case when the circuit include a central processing unit (CPU). Simulating a CPU across a range of instructions can take many hours or even days as instructions are simulated on a clock cycle basis across the whole circuit. Additionally, insights into errors may be complex and limited given sometimes overwhelming amounts of data produced by the simulation.

The present disclosure is directed to improving simulation of circuits.

### BRIEF DESCRIPTION OF THE DRAWINGS

FIG. 1 illustrates a system for simulating a circuit according to an embodiment.

FIG. 2 illustrates a method for simulating a circuit according to an embodiment.

FIG. 3 illustrates an example system for simulating a circuit according to an embodiment.

FIG. 4 illustrates an example method for simulating a circuit according to an embodiment.

FIG. 5 illustrates hardware of a special purpose computing system configured according to the above disclosure.

### DETAILED DESCRIPTION

Described herein are techniques for firmware development and/or validation. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

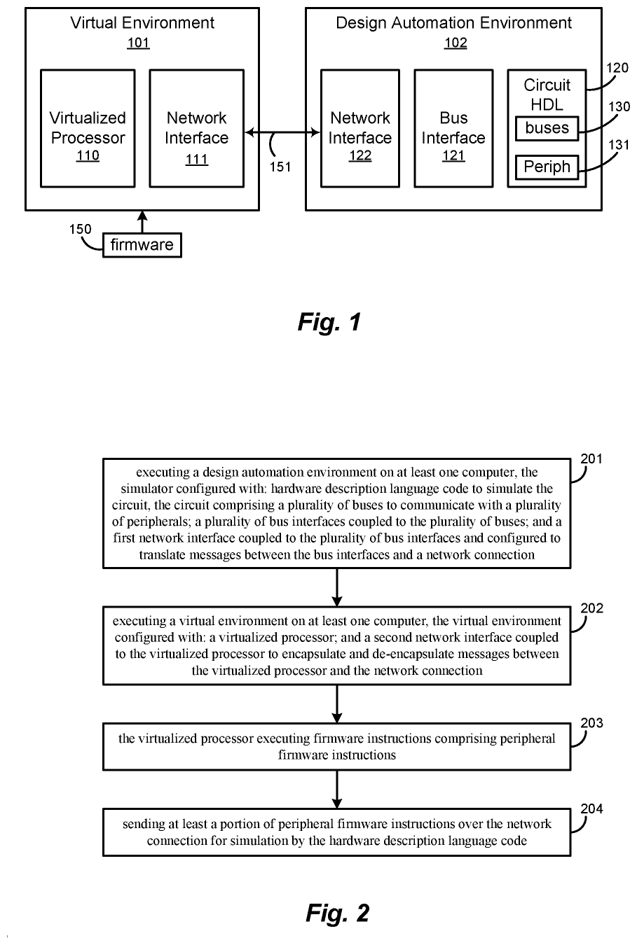

FIG. 1 illustrates a system for simulating a circuit according to an embodiment. Features and advantages of the present disclosure include using a virtualized processor to run certain instructions on a circuit under development during simulation. The circuit may be embodied as a hardware description language (HDL) code, which is executed in a design automation environment. In some embodiments, the HDL code may be Verilog or register transfer logic (RTL) code, for example. The circuit may include a processor, for example, but certain processor functions are not simulated in HDL. Rather, certain processor functions, such as firmware instructions may be performed on a virtualized processor, which provides faster results than an HDL version of the processor.

In the present embodiment of FIG. 1, a design automation environment 102, operable on at least one computer, is configured with HDL code to simulate a circuit 120. The circuit may be a digital circuit, for example, and may include one or more processors coupled to one or more functional blocks (e.g., peripherals 131) over one or more buses 130. Loading circuit HDL 120 in design automation environment 102 may allow for simulation of circuit 120 to verify that the circuit operates and performs as desired. Verification of one or more circuits in a design automation environment is sometimes referred to as “test bench.” Design automation environment 102 further includes a plurality of bus interfaces 121. Bus interfaces 121 may allow for communications with buses 130 and peripherals 131 from other resources in the design automation environment (e.g., signal generators or data collection components external to circuit HDL 120 for interacting with peripherals 131).

As mentioned above, virtual environment 101 includes a virtualized processor 110 for executing certain instructions that would otherwise be performed by a one or more processors on the circuit HDL 120 being verified. For example, it may be desirable, as part of the verification process, to execute and test instructions in firmware 150. Firmware 150 may include instructions that interact (or cause interaction with) peripherals 131 (referred to herein as peripheral firmware instructions). Virtualized processor 110 may execute firmware instructions comprising peripheral firmware instructions. Advantageously, at least a portion of peripheral firmware instructions are sent over the network connection for simulation by circuit HDL code 120. For example, design automation environment 102 may include a network interface 122 coupled to bus interfaces 121 and configured to translate messages between the bus interfaces 121 and a network connection 151. Similarly, virtual environment 101 may include network interface 111 coupled to virtualized processor 110 to encapsulate and de-encapsulate messages between virtualized processor 110 and network connection 151. Accordingly, a peripheral firmware instruction may be executed by virtualized processor 110, resulting in a message being produced by virtualized processor 110 and sent to network interface 111. Network interface 111 may encapsulate the message (e.g., in a network packet) and send the message over connection 151 to network interface 122. Network interface 122 may receive the message and translate the message into instructions on a particular bus interface 121, for example. The message is coupled through the bus interface 121 to a bus on circuit HDL 120, and the execution message simulates execution of the peripheral firmware instruction in circuit HDL 120. Advantageously, a portion of firmware instructions may be executed on virtualized processor 110 and other portions of firmware instructions may be simulated in circuit HDL 120. For example, some firmware instructions may not involve peripherals, or may simply perform processor steps and return information to a user. Advantageously, some firmware instructions are processed by virtualization processor, which is faster than execution of such firmware instructions by an HDL simulator. Other firmware instructions, such as peripheral firmware instructions can be advantageously simulated in circuit HDL 120 without the burden of simulating all firmware instructions in an HDL simulator. Performing processor functionality on the virtualized processor during simulation may reduce verification time and speed up the development process of a circuit, for example.

FIG. 2 illustrates a method for simulating a circuit according to an embodiment. At 201, a design automation environment is executed on at least one computer, such as a server (e.g., the “EDA computer”). The design automation environment may be configured with: HDL code to simulate a circuit, a plurality of bus interfaces, and a network interface. The circuit includes a plurality of buses to communicate with a plurality of peripherals. The plurality of bus interfaces is coupled to the plurality of buses. The network interface is coupled to the plurality of bus interfaces and configured to translate messages between the bus interfaces and a network connection. At 202, a virtual environment is executed on at least one computer. The virtual environment may be operable on a host computer, such as a server, for example, which may be coupled to the EDA computer over a network (e.g., Ethernet). The virtual environment may be configured with: a virtualized processor; and another network interface coupled to the virtualized processor to encapsulate and de-encapsulate messages between the virtualized processor and the network connection. At 203, the virtualized processor executes firmware instructions comprising peripheral firmware instructions. At 204, at least a portion of peripheral firmware instructions are sent over the network connection for simulation by the HDL code.

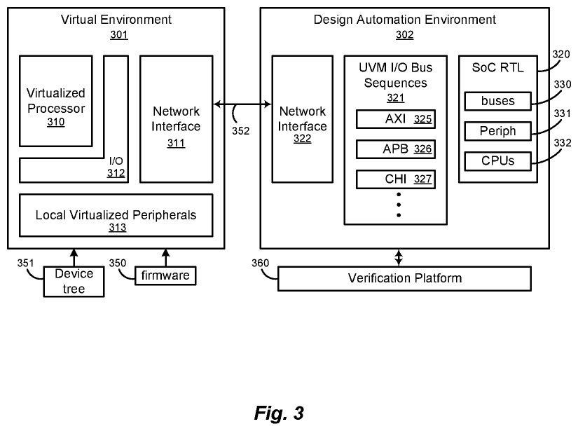

FIG. 3 illustrates an example system for simulating a circuit according to an embodiment. In this example, a design automation environment 302 runs on a verification platform 360, such as Synopsys VCS®, which is a functional verification solution providing simulation and constraint solver engines. Here, the circuit being verified is a system-on-a-chip (SoC) RTL 320, which may comprise one or more processors 332, peripherals 331 for performing a wide variety of functions, and one or more buses 330. Peripherals may include a wide variety of functional blocks on the SoC, including, but not limited to, SRAM, UART, DMA control, I2C, etc., Buses 330 may be simulated using Universal Verification Methodology, which is a validation method to run simulation and do system IP verification. Buses may include AXI bus protocol 325, APB bus protocol 326, CHI bus protocol 327, or the like, which provide an interface to the SoC RTL 320. For instance, these components may issue traffic from an external virtual CPU to buses in RTL. As mentioned above, since CPUs 332 are deactivated (or excluded from) SoC RTL code 320, bus interfaces 321 provide access to the RTL buses and peripherals.

In digital circuit design, register-transfer level (RTL) code models a synchronous digital circuit in terms of the flow of digital signals (data) between hardware registers, and the logical operations performed on those signals. Register transfer level (RTL) defines the digital portions of a design to model in the design and verification flow.

In this example, a virtual environment 301 comprises virtualized processor 310, I/O 312, network interface 311, and virtualized peripherals 313. Virtual environment 301 may be implemented using QEMU, for example, which is a generic and open source machine emulator and virtualizer. QEMU emulates a computer's processor through dynamic binary translation and provides a set of different hardware and device models for the machine, enabling it to run a variety of guest operating systems. It can interoperate with Kernel-based Virtual Machine (KVM) to run virtual machines at near-native speed. QEMU can also do emulation for user-level processes, allowing applications compiled for one architecture to run on another. When used as a virtualizer, QEMU achieves near native performance by executing the guest code directly on the host CPU. QEMU supports virtualization when executing under the Xen hypervisor or using the KVM kernel module in Linux. When using KVM, QEMU can virtualize x86, server and embedded PowerPC, 64-bit POWER, S390, 32-bit and 64-bit ARM, and MIPS guests, for example. It is to be understood that QEMU is just one example virtual environment shown to illustrate the present techniques. Other virtual environments may be used, such as virtual machines from VMWare or any virtualization environment. While virtualized processor 310 runs on a physical host CPU, such as an x86, processor 310 can virtualize ARM, RISC, or any other CPU type, for example.

Verification may include execution of firmware 350 against the SoC RTL 320. However, as indicated above, RTL for the SoC CPUs 332 may be inactive (or removed) during verification. Accordingly, simulation of the SoC is performed without using RTL code for the SoC processor. Rather, the SoC processor functionality is performed, during simulation, by the virtualized processor 310. Firmware 350 may comprise a microcode or program that is embedded into the memory of hardware devices to help them operate. Firmware may be used to enable hardware like cameras, mobile phones, network cards, optical drives, printers, routers, scanners, and television remotes to function smoothly. Firmware is sometimes considered a foundation of the software stack that computer hardware uses for basic operations and to run applications. Hardware makers may use embedded firmware to control the functions of various hardware devices and systems, much like a computer's operating system (OS) controls the function of software applications. One example of firmware in computing is the BIOS (Basic Input/Output System, also known as the System BIOS, ROM BIOS, BIOS ROM or PC BIOS). BIOS is firmware used to provide runtime services for operating systems and programs and to perform hardware initialization during the booting process (power-on startup).

Some firmware functions may be fully completed in virtual processor 310. For example, a simple addition function required by firmware (A+B=C) does not need to be communicated to RTL. Completing some firmware functions on virtual processor 310 saves cycles. On the other hand, other firmware functions may require the CPU to talk to a peripheral on the SoC. Accordingly, some firmware functions are coupled to the SoC RTL 320 and RTL peripherals 331. In some cases, some firmware functions against peripherals may be emulated. For example, when a firmware function on a peripheral does not impact behavior of the system. (e.g., it results in status messages for human interaction during debug), such peripherals may also be virtualized. Accordingly, virtual environment 301 includes local virtualized peripherals 313 to execute certain peripheral firmware instructions.

Virtual environment 301 further includes an input/output controller (I/O) 312 coupled to the virtualized processor 310. I/O 312 is configured to receive messages from the virtualized processor and send the messages to network interface 311 for simulation by the RTL code or local virtualized peripherals 313 for execution on local virtualized peripherals 313. I/O 312 may act as a filter between virtual processor 310 and peripherals implemented as RTL or emulated. I/O 312 may determine if peripheral messages from virtualized processor 310 can be sent to virtual peripherals or if they need to be sent to RTL peripherals, for example. For example, virtualized processor 310 may read or write (R/W) traffic to or from other functional blocks (e.g., peripherals). I/O 312 may determine, based on a R/W address from virtualized processor 310, whether to send traffic to local virtualize peripherals 313 or RTL peripherals 331. In various embodiments, I/O 312 is custom code, which may be implemented as C, Python, for example, to determine a path for the traffic to/from processor 310. In this example, virtual environment 301 receives a device tree 351. Device tree 351 may specify a plurality of host peripherals that are used to emulate local virtualized peripherals 313. In some embodiments, device tree 351 may describe what kind of peripheral devices are on the host computer system running the virtualization environment 301, for example.

For peripheral firmware instructions executed against peripherals 331 in RTL, virtualized processor 310 generates peripheral messages, which are routed by I/O 312 to network interface 311. For example, the messages may comprise an address used by I/O 312 to route the message to network interface 311. Network interface 311 encapsulates messages from the virtualized processor 310 in TCP/IP packets for transmission over the network connection 352 (e.g., an Ethernet connection, an Intranet connection, Internet connection, or cloud network connection). TCP/IP stands for Transmission Control Protocol/Internet Protocol. TCP/IP is a set of standardized rules that allow computers to communicate on a network such as the internet. The TCP/IP protocol supports two types of ports: TCP Port and UDP Port. TCP is typically for connection orientated applications and has built in error checking and will re-transmit missing packets. UDP is typically for connectionless applications.

Network interface 322 forwards the messages in the TCP/IP packets to one of the bus interfaces 302 and a corresponding one of the plurality of peripherals 331 over one of the plurality of buses for simulation by SoC RTL code 320. For instance, network interface 322 receives the TCP/IP packets over connection 352 and unpacks the messages. Network interface 322 may map the message to one bus interfaces 321 based on an address in the message. For example, one message having a first address may be mapped to the AXI bus interface 325 and a corresponding peripheral for simulation by RTL code. Another message having a second address may be mapped to the APB bus interface and another corresponding peripheral for simulation by the RTL code. As a more specific example, a write message to address 1000 with a value ‘1234’ may be forwarded to APB bus. While the present example illustrates mapping messages to particular buses and peripherals on the design automation environment network interface 322 side of connection 352, it is to be understood that such mapping may be performed in the virtual environment network interface 311 side of connection 352. However, in some example embodiments, having network interface 322 perform the mapping may be advantageous because design automation environment 302 may have more efficient access to the mapping between the addresses and the bus interfaces and peripherals, for example. Network interface 322 may be implemented using a System Verilog Direct Programming Interface (DPI), which is an interface between System Verilog and a foreign programming language. Example implementations of network interface may be done using the C programming language as an interface to Verilog code. C code may process incoming TCP/IP packets and convert the packets to a Verilog environment, which can transfer the traffic to/from the bus interfaces 321, for example. DPI may allow a designer to call C functions from SystemVerilog and to export SystemVerilog functions, so that they can be called from C, for example.

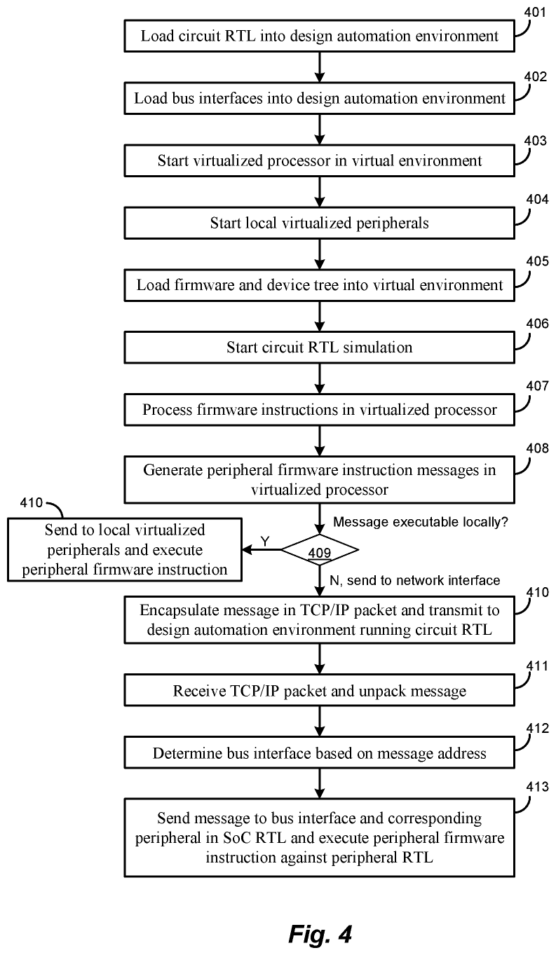

FIG. 4 illustrates an example method for simulating a circuit according to an embodiment. At 401, circuit RTL is loaded into a design automation environment. At 402, bus interfaces (UVM) are loaded into design automation environment. At 403, a virtualized processor is started in a virtual environment. At 404, local virtualized peripherals are started. At 405, firmware and a device tree are loaded into the virtual environment. At 406, the circuit RTL simulation is started. At 407, firmware instructions are processed in the virtualized processor. At 408, peripheral firmware instruction messages are generated in virtualized processor. At 409, I/O controller determines if peripherals for messages are executable by local virtualized peripheral or remote RTL peripherals. If local, then the messages are sent to local virtualized peripherals, which execute peripheral firmware instruction. If not local, then the messages are sent to a network interface. At 410, messages are encapsulated in TCP/IP packets and transmitted to a design automation environment running a circuit RTL simulation. At 411, the TCP/IP packets are received by a network interface and the messages are unpacked. At 412, network interface determines which bus interface to send the messages to based on a message address. At 413, the messages are sent to a bus interface and corresponding peripheral in the SoC RTL and peripheral firmware instruction is executed against the peripheral RTL

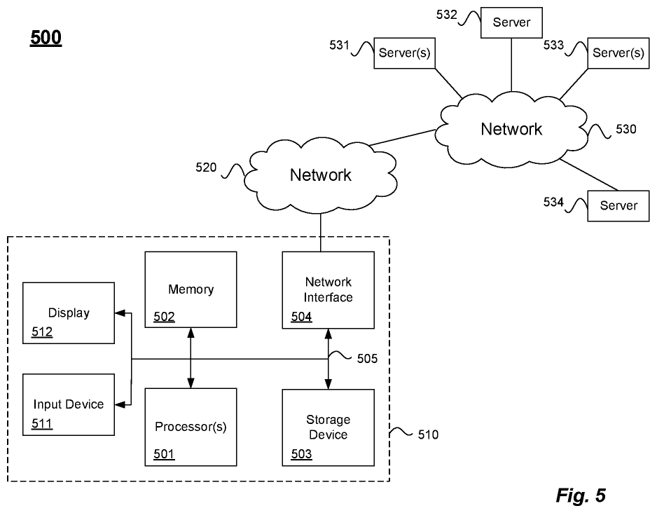

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a frontend (e.g., a browser), for example, may access data and features on backend software systems that may reside on multiple different hardware servers on-prem 531 or across the network 530 (e.g., an Extranet or the Internet) on servers 532-534. One or more of servers 532-534 may also reside in a cloud computing environment, for example.

### Further Examples

Each of the following non-limiting features in the following examples may stand on its own or may be combined in various permutations or combinations with one or more of the other features in the examples below. In various embodiments, the present disclosure may be implemented as a processor or method.

In one embodiment, the present disclosure includes a computer system for simulating a circuit comprising: a design automation environment, operable on at least one computer, the design automation environment configured with: hardware description language code to simulate the circuit, the circuit comprising a plurality of buses to communicate with a plurality of peripherals; a plurality of bus interfaces coupled to the plurality of buses; and a first network interface coupled to the plurality of bus interfaces and configured to translate messages between the bus interfaces and a network connection; and a virtual environment, operable on at least one computer, the virtual environment configured with: a virtualized processor; and a second network interface coupled to the virtualized processor to encapsulate and de-encapsulate messages between the virtualized processor and the network connection, wherein the virtualized processor executes firmware instructions comprising peripheral firmware instructions, and wherein at least a portion of peripheral firmware instructions are sent over the network connection for simulation by the hardware description language code.

In another embodiment, the present disclosure includes a method of simulating a circuit comprising: executing a design automation environment on at least one computer, the design automation environment configured with: hardware description language code to simulate the circuit, the circuit comprising a plurality of buses to communicate with a plurality of peripherals; a plurality of bus interfaces coupled to the plurality of buses; and a first network interface coupled to the plurality of bus interfaces and configured to translate messages between the bus interfaces and a network connection; and executing a virtual environment on at least one computer, the virtual environment configured with: a virtualized processor; and a second network interface coupled to the virtualized processor to encapsulate and de-encapsulate messages between the virtualized processor and the network connection, wherein the virtualized processor executes firmware instructions comprising peripheral firmware instructions, and wherein at least a portion of peripheral firmware instructions are sent over the network connection for simulation by the hardware description language code.

In one embodiment, the circuit is a system-on-a-chip (SoC) comprising an SoC processor, and wherein simulation of the SoC is performed without using hardware description language code for the SoC processor, and wherein the SoC processor functionality is performed, during simulation, by the virtualized processor.

In one embodiment, the virtual environment further comprising a plurality of local virtualized peripherals, wherein at least a second portion of peripheral firmware instructions are executed on the plurality of local virtualized peripherals.

In one embodiment, the virtual environment further comprising an input/output controller coupled to the virtualized processor, the I/O controller configured to receive messages from the virtualized processor and send the messages to one of: the second network interface for simulation by the hardware description language code; and the plurality of local virtualized peripherals for execution on the plurality of local virtualized peripherals.

In one embodiment, the system further comprising a device tree specifying a plurality of host peripherals used to emulate the plurality of local virtualized peripherals.

In one embodiment, the network connection is a TCP/IP connection, and wherein the second network interface encapsulates messages from the virtualized processor in TCP/IP packets for transmission, and wherein the first network interface forwards the messages in the TCP/IP packets to one of the plurality of bus interfaces and a corresponding one of the plurality of peripherals over one of the plurality of buses for simulation by the hardware description language code.

In one embodiment, the messages comprise an address, and wherein the first network interface maps the address to said one of the plurality of bus interfaces.

In one embodiment, a first message having a first address is mapped to a first bus interface and a corresponding first peripheral for simulation by the hardware description language code, and wherein a second message having a second address is mapped to a second bus interface and a corresponding second peripheral for simulation by the hardware description language code.

In one embodiment, the plurality of bus interfaces is simulated used universal verification methodology (UVM).

In one embodiment, the hardware description language code is register transfer logic (RTL) code.

In one embodiment, the design automation environment is operable on a first computer and the virtual environment is operable on a host computer.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A computer system for simulating a circuit comprising:
a design automation environment, operable on at least one computer, the design automation environment configured with:
hardware description language code to simulate the circuit, the circuit comprising a plurality of buses to communicate with a plurality of peripherals;
a plurality of bus interfaces coupled to the plurality of buses; and
a first network interface coupled to the plurality of bus interfaces and configured to translate messages between the bus interfaces and a network connection; and
a virtual environment, operable on at least one computer, the virtual environment configured with:
a virtualized processor; and
a second network interface coupled to the virtualized processor to encapsulate and de-encapsulate messages between the virtualized processor and the network connection,
wherein the virtualized processor executes firmware instructions comprising peripheral firmware instructions, and wherein at least a portion of peripheral firmware instructions are sent over the network connection for simulation by the hardware description language code.

2. The system of claim 1, wherein the circuit is a system-on-a-chip (SoC) comprising an SoC processor, and wherein simulation of the SoC is performed without using hardware description language code for the SoC processor, and wherein the SoC processor functionality is performed, during simulation, by the virtualized processor.

3. The system of claim 1, the virtual environment further comprising a plurality of local virtualized peripherals, wherein at least a second portion of peripheral firmware instructions are executed on the plurality of local virtualized peripherals.

4. The system of claim 3, the virtual environment further comprising an input/output controller coupled to the virtualized processor, the I/O controller configured to receive messages from the virtualized processor and send the messages to one of:
the second network interface for simulation by the hardware description language code; and
the plurality of local virtualized peripherals for execution on the plurality of local virtualized peripherals.

5. The system of claim 3, further comprising a device tree specifying a plurality of host peripherals used to emulate the plurality of local virtualized peripherals.

6. The system of claim 1, wherein the network connection is a TCP/IP connection, and wherein the second network interface encapsulates messages from the virtualized processor in TCP/IP packets for transmission, and wherein the first network interface forwards the messages in the TCP/IP packets to one of the plurality of bus interfaces and a corresponding one of the plurality of peripherals over one of the plurality of buses for simulation by the hardware description language code.

7. The system of claim 6, wherein the messages comprise an address, and wherein the first network interface maps the address to said one of the plurality of bus interfaces.

8. The system of claim 7, wherein a first message having a first address is mapped to a first bus interface and a corresponding first peripheral for simulation by the hardware description language code, and wherein a second message having a second address is mapped to a second bus interface and a corresponding second peripheral for simulation by the hardware description language code.

9. The system of claim 1, wherein the plurality of bus interfaces is simulated used universal verification methodology (UVM).

10. The system of claim 1, wherein the hardware description language code is register transfer logic (RTL) code.

11. The system of claim 1, wherein the design automation environment is operable on a first computer and the virtual environment is operable on a host computer.

12. A method of simulating a circuit comprising:
executing a design automation environment on at least one computer, the design automation environment configured with:
hardware description language code to simulate the circuit, the circuit comprising a plurality of buses to communicate with a plurality of peripherals;
a plurality of bus interfaces coupled to the plurality of buses; and
a first network interface coupled to the plurality of bus interfaces and configured to translate messages between the bus interfaces and a network connection; and
executing a virtual environment on at least one computer, the virtual environment configured with:
a virtualized processor; and
a second network interface coupled to the virtualized processor to encapsulate and de-encapsulate messages between the virtualized processor and the network connection,
wherein the virtualized processor executes firmware instructions comprising peripheral firmware instructions, and wherein at least a portion of peripheral firmware instructions are sent over the network connection for simulation by the hardware description language code.

13. The method of claim 12, wherein the circuit is a system-on-a-chip (SoC) comprising an SoC processor, and wherein simulation of the SoC is performed without using hardware description language code for the SoC processor, and wherein the SoC processor functionality performed, during simulation, by the virtualized processor.

14. The method of claim 12, the virtual environment further comprising a plurality of local virtualized peripherals, wherein at least a second portion of peripheral firmware instructions are executed on the plurality of local virtualized peripherals.

15. The method of claim 14, the virtual environment further comprising an input/output controller coupled to the virtualized processor, the I/O controller configured to receive messages from the virtualized processor and send the messages to one of:
the second network interface for simulation by the hardware description language code; and
the plurality of local virtualized peripherals for execution on the plurality of local virtualized peripherals.

16. The method of claim 14, further comprising a device tree specifying a plurality of host peripherals used to emulate the plurality of local virtualized peripherals.

17. The method of claim 1, wherein the network connection is a TCP/IP connection, and wherein the second network interface encapsulates messages from the virtualized processor in TCP/IP packets for transmission, and wherein the first network interface forwards the messages in the TCP/IP packets to one of the plurality of bus interfaces and a corresponding one of the plurality of peripherals over one of the plurality of buses for simulation by the hardware description language code.

18. The method of claim 17, wherein the messages comprise an address, and wherein the first network interface maps the address to said one of the plurality of bus interfaces.

19. The method of claim 18, wherein a first message having a first address is mapped to a first bus interface and a corresponding first peripheral for simulation by the hardware description language code, and wherein a second message having a second address is mapped to a second bus interface and a corresponding second peripheral for simulation by the hardware description language code.

20. The method of claim 1, wherein the hardware description language code is register transfer logic (RTL) code.
